(19) United States
(12) Patent Application Publication
(10) Pub. No.: US 2014/0259699 A1
(43) Pub. Date: Sep. 18, 2014

(54) FLEXIBLE SAW BLADES AND METHODS FOR CURVATURE CUTTING

(71) Applicant: Benjamin Yang, Portland, OR (US)

(72) Inventor: Benjamin Yang, Portland, OR (US)

(21) Appl. No.: 14/203,331

(22) Filed: Mar. 10, 2014

Related U.S. Application Data
(60) Provisional application No. 61/851,865, filed on Mar. 14, 2013.

(51) Int. Cl. B23D 61/18; B26D 1/46

(52) U.S. Cl. CPC B23D 61/18; B26D 1/46
USPC 30/380; 30/166.3; 30/520

(57) ABSTRACT

Saws including saws configured to allow change in a width, a direction, and a curvature of a cut during a cutting operation are described. The saws include a saw blade, the saw blade being flexible along a longitudinal axis of the saw blade and inflexible along a vertical axis of the saw blade. The saw blade includes a blade body, and a plurality of cutting teeth, the plurality of cutting teeth being disposed on an upper cutting edge of the blade and a lower cutting edge of the blade body. In some examples, the saw blade is configured to be flexed by manipulation of at least two articulating points on the saw blade during the cutting operation to change one or more of the kerf, the direction, and the curvature of the cut.

### CROSS REFERENCE TO RELATED APPLICATIONS

This application claims priority to co-pending U.S. Application Ser. No. 61/851,865, filed on Mar. 14, 2013, which is hereby incorporated by reference for all purposes.

### BACKGROUND

The present disclosure relates generally to cutting blades where the depth, the direction, and/or the curvature can be adjusted while engaged in a cutting operation. In particular, flexible saw blades for cutting curvatures and methods of use are described.

In the field of working and recreating in cold and snowy wilderness areas, an emergency shelter can be a lifesaver. A tent can provide such a shelter, but it is vulnerable to wind and snow loading. Further, a tent provides no insulation from the cold. Snow caves can provide the necessary protection from extreme cold, driving wind and blinding snowy conditions. However, it can take hours to excavate even a small snow cave.

A proper snow cave should have a small door to keep the weather out and the heat in. The living chamber should have a low vaulted ceiling so the heat is kept where the occupants reside. And, the walls should be smoothed so any drips are directed down the walls and not on the occupants.

A snow cave is built by tunneling a narrow passage into a snow bank. Then, this passage is opened up into a low rounded chamber. The waste snow is discharged through the door. A short handled snow shovel is the traditional tool used to chop the snow into pieces small enough that they can be moved toward the door. The deeper and older snow can be quite dense and difficult to chop up with the shovel, especially when working in the limited confines of the growing cavity.

A good snow saw can easily cut the dense snow, but it leaves an uneven wall and generates lots of small pieces that still have to be removed from the cave.

Known snow saws are not entirely satisfactory for the range of application in which they are employed. For example, existing snow saws leave an uneven wall and generate lots of small pieces of ice and snow pack that are difficult to remove from the cave. Further, there is no way to excavate a block of snow with a single cut using existing snow saws because a straight-bladed saw cannot sever the backside of a block.

A shovel is another common tool used for snow cave excavation. While it is very useful for chopping dense pieces out of the wall and moving powder and small pieces, it cannot cut big pieces and cannot cut the backside of a block either. It can take many grueling hours to remove enough dense, hard snow in a confined space to make a useful emergency shelter.

Thus, there exists a need for snow saws that improve upon and advance the design of known snow saws. Examples of new and useful flexible saw blades for cutting curvatures and methods of use relevant to the needs existing in the field are discussed below.

Disclosure addressing one or more of the identified existing needs is provided in the detailed description below. Examples of references relevant to saws include U.S. Pat. Nos. References: 7,143,678 and 8,621,967. The complete disclosures of the above patents are herein incorporated by reference for all purposes.

### SUMMARY

The present disclosure is directed to saws configured to allow change in a width, a direction, and a curvature of a cut during a cutting operation. The saw includes a saw blade, the saw blade being flexible along a longitudinal axis of the saw blade and inflexible along a vertical axis of the saw blade. The saw blade includes a blade body, and a plurality of cutting teeth, the plurality of cutting teeth being disposed on a lower cutting edge of the blade body. In some examples, the plurality of cutting teeth are also disposed on an upper cutting edge of the blade body. Further, in some examples, the saw blade is configured to be flexed by manipulation of at least two articulating points on the saw blade during the cutting operation to change one or more of the kerf, the direction, and the curvature of the cut.

### BRIEF DESCRIPTION OF THE DRAWINGS

FIG. 1 is a perspective view of a first example of a flexible saw being operated by a user.

FIG. 2 is a perspective view of the flexible saw of in FIG. 1 depicting a more detailed view of the handles and the blade body.

FIG. 3 is a perspective view of the flexible saw of FIG. 1 in a coiled storage position.

FIG. 4 is a top plan view of the flexible saw of FIG. 1 being used in a cutting operation to make an acute curvature cut.

FIG. 5 is a top plan view of the flexible saw of FIG. 1 being used in a cutting operation to make a medium curvature cut.

FIG. 6 is a top plan view of the flexible saw of FIG. 1 being used in a cutting operation to make an obtuse curvature cut.

FIG. 7 is a top plan view of the flexible saw of FIG. 1 being used in a cutting operation to make an rounded curvature cut.

FIG. 8 is a top plan view of a second example of a flexible saw including a ring-shaped blade with sets of rollers for manipulating and/or articulating the saw blade.

FIG. 9 is a top plan view of a set of rollers for the flexible saw blade of FIG. 8 adjusted to form a more acute angle in a flexed saw blade.

FIG. 10 is a top plan view of a set of rollers for the flexible saw blade of FIG. 8 adjusted to form a less acute angle in a flexed saw blade.

FIG. 11 is a top plan view of the flexible saw of FIG. 8 being used in a cutting operation to make an obtuse curvature cut.

FIG. 12 is a top plan view of the flexible saw of FIG. 8 being used in a cutting operation to make an acute curvature cut.

FIG. 13 is a top plan view of the flexible saw of FIG. 8 being used in a cutting operation to make an ogee curvature cut.

FIG. 14 is a perspective view of an example saw blade including an embedded abrasive material that can be used in either of the first example saw of FIG. 1 or the second example saw of FIG. 8.

### DETAILED DESCRIPTION

The disclosed flexible saw blades for cutting curvatures and methods of use will become better understood through review of the following detailed description in conjunction with the Figures. The detailed description and Figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various flexible saw blades for cutting curvatures and methods of use are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given Figure or example.

Generally, this invention relates to a saw blade that is flexible along its longitudinal axis, and rigid (i.e., inflexible) along its vertical axis. As depicted in FIGS. 1-11, flexible saw blades are configured in an arc or a ring and can be manipulated on at least two articulating or supporting points. The material being cut is located between these points. The flexible saw blades can reciprocate (in the arc configuration) or orbit (in the ring or arc configuration). The flexible saw blades can be flexed along the plane in which the profile is formed, thus allowing different profiles and curvatures to be cut (i.e., various widths, curvatures, and directions of a cut). Further, the flexible saw blades can be used to change the width, curvature, and/or direction of a cut during a cutting operation. Furthermore, the flexible saw blades are rigid enough along the vertical axis that they can make plunge cuts and be fed into the work piece while being guided/steered/flexed by the articulated supporting points (i.e., articulating points).

Accordingly, objects and advantages of this invention include: providing a tool and a method of use that will enable plunge cuts and the rapid excavation of a vaulted cavity in the snow for the purpose of constructing an emergency shelter, and to provide a tool that can transition between different profiles (e.g., widths, curvatures, and/or directions) during a single pass of the tool on the work piece (e.g., a snow pack). Further, the presently described flexible saw blades and methods of use can be used in other curvature cutting applications, such as earth excavation, CNC profile/trim and edging, tunneling/boring in earth, artistic and sculptural, etc.

FIG. 1 shows a first example flexible saw blade, saw 100, engaged as a snow saw in a snow cutting operation. As depicted in FIG. 1, a user 102 is operating the two-handled, hand-saw, saw 100, in a reciprocating fashion. A snow pack 104 is being cut in a generally downward trending direction. During the cutting operation a plane of cut is shown to change in the curvature and the direction over the course of a cut 106.

The curvature in the plane of cut 106 can be changed by manipulating handles 108 (i.e., a right-handed handle 112 and a left-handed handle 114 shown in FIGS. 2 and 3). Holding handles 108 further apart enables the user to cut a larger radius kerf. Holding handles 108 closer together allows user 102 to cut a smaller width and greater degree of curvature for the cut, while holding handles 108 farther apart allows user 102 to cut a greater width and lessor degree of curvature for the cut. Thus handles 108 are articulating points that are configured to allow change one or more of the width, the direction, and the curvature of the cut during the cutting operation.

While a blade 110 (i.e., blade body) of saw 100 is flexible along its longitudinal axis, it is rigid or inflexible along its vertical axis. This rigidity in the cutting plane (e.g., the vertical plane) permits the operator to keep a plurality of cutting teeth 116 (shown in FIGS. 2 and 3) engaged in the fresh uncut snow in such a way that saw 100 can make forward progress through snow pack 104 while its direction, kerf, and curvature are being adjusted.

FIG. 2 shows saw 100 in a flexed position 118. As stated above, saw 100 includes blade 110 with a right-handed handle 112 and a left-handed handle 114 (i.e., handles 108). In the present example, blade 110 is has a greater longitudinal length and a lessor vertical height. Blade 110 can be made of a material with an elastic memory, such as spring steel, that can be repeatedly flexed without being permanently deformed. Blade 110 includes cutting teeth 116 on each of an upper cutting edge 120 and a lower cutting edge 122.

Blade 110 is more flexible along its longitudinal axis A-A and more rigid and/or inflexible along its vertical axis B-B (i.e., an axis of the direction of cutting). The user can flex and manipulate saw 100 in the flexible longitudinal axis A-A to adjust one or more of the width, the direction, and the curvature of the cut while the saw is engaged in the cutting operation. Because saw 100 is rigid in vertical axis B-B (i.e., the cutting axis), the saw can be levered by handles 108 in such a way that cutting teeth 116 can substantially remain engaged in the work piece (e.g., snow pack 104) in the desired cutting direction at a desired kerf and curvature.

Saw 100 can be used by grasping right-handed handle 112 in a right hand 126 and left-handed handle 114 in a left hand 128, and flexing the blade into an arc 130. Arc 130 will prescribe the width and the curvature of a cut. Arc 130 can be adjusted by moving the handles closer and/or farther apart. As stated above, moving handles 108 closer together allows user 102 to cut a smaller width and greater degree of curvature for the cut, while moving handles 108 farther apart allows user 102 to cut a greater width and lessor degree of curvature for the cut.

Once the desired starting width and curvature is determined, cutting teeth 116 of blade 110 can be engaged with snow pack 104 (shown in FIG. 1). User 102 (i.e., an operator of saw 100) can begin a reciprocating motion with his/her hands. The pressure of cutting teeth 116 in the uncut snow can be adjusted by levering handles 108 in the cutting direction (e.g., a downward direction, an upward direction, etc.). The saw can be steered left, by levering and sawing faster with right handle 112. Further, the saw can be steered right by levering and sawing faster with left handle 114. The depth and direction of blade 110 in snow pack 104 can also be adjusted by levering both handles 108 to increase or decrease an angle of blade 110.

In a typical snow excavation operation or method, saw 100 is manipulated into an arc that prescribes the desired width and curvature of the cut. The saw blade is brought to the vertical surface of the snow where sawing is to begin. The arc 130 of the saw blade 110 allows it to saw into the surface plane of the work-piece (i.e., snow pack 104) and cut the backside of the block that is being excavated in a scooping fashion. Next, the cut is made downward with the desired curvature. Then blade 110 is steered back to the surface of the snow where it can exit the snow bank.

This operation will completely sever a curved block of snow (i.e. bolus) from the snow bank. If the bolus does not fall out when the cut is complete, it can be removed by reinserting the blade back into the cut and then tugging until the bolus is lifted or falls out. In the presently described example, saw 100 can also be used as a rasp to shape and abrade the snow. Further, saw 100 can be used as a hoe to drag and scrape snow from one place to another.

FIG. 3 shows saw 100 coiled up in a storage position 132 for easier packing and/or storage. This can be advantageous for carrying saw 100 in back country conditions where supplies must be carried by the user/operator.

FIGS. 4-7 show example cut configurations for saw 100. FIG. 4 depicts saw 100 in snow pack 104 flexed at an acute curvature 134 with a width a between handles 108. FIG. 5 depicts saw 100 in snow pack 104 flexed at a medium curvature 136 at with a width b between handles 108. FIG. 6 depicts saw 100 in snow pack 104 flexed at an obtuse curvature 138 with a width c between handles 108.

In the examples of FIGS. 4-6, the width a is less than the width b, and the width b is less than the width c. Further, the degree of curvature of curvature 134 is greater than curvature 136, and curvature 136 is greater than curvature 138. Thus, in these examples, the width of the cut and the degree of curvature generally have an inverse relationship.

In other examples, the width of the cut and the degree of curvature may not have an inverse relationship. For example, FIG. 7 depicts saw 100 in snow pack 104 flexed at rounded curvature 140 with a width d between handles 108. In this example, as shown in FIGS. 5 and 7, width d is less than the width b; however, the degree of curvature is substantially similar between curvatures 136 and 140. The shape of curvature 140 has a more rounded shape than curvature 136 by selectively angling handles 108 in a more outwardly direction, while the shape of curvature 136 is less rounded by angling handles 108 in a more inwardly direction. Thus, manipulation of handles 108 can also be used to change the shape of a cut as desired during a cutting operation.

Turning attention to FIGS. 8-13, a second example of a flexible saw, saw 200 will now be described. Saw 200 includes many similar or identical features to saw 100. Thus, for the sake of brevity, each feature of saw 200 will not be redundantly explained. Rather, key distinctions between saw 200 and saw 100 will be described in detail and the reader should reference the discussion above for features substantially similar between the two flexible saw blades.

Specifically, saw 200 is in a ring configuration, including a continuous ring-shaped blade 210. Saw 200 includes sets of rollers 208 including a first set of rollers 212 (i.e., a set of rollers on a right side) and a second set of rollers 214 (i.e., a set of rollers on a left side). Ring-shaped blade 210 is flexed into different curvatures by sets of rollers 208. In this example, the sets of rollers are the articulating and/or supporting points of the saw blade. The sets of roller guide and support the ring-shaped blade as it moves along a longitudinal axis in a cutting motion.

Saw 200 can be used to cut a work piece 204 (e.g., a snow pack, ice, a plastic block, a clay block, wood, etc.). The blade is driven in either a reciprocating or a circular fashion by a drive mechanism 242. In one specific example, the drive mechanism is a gas powered motor. In another specific example, the drive mechanism is an electric motor. Alternatively, the rollers may be employed as a drive mechanism, and drive mechanism 242 can be eliminated from saw 200.

FIGS. 9 and 10 show example configurations for sets of rollers 208. Each set of rollers 208 (i.e., right side set of rollers 212 and left side set of rollers 214) includes a center roller 244 and two outer rollers 246. It will be appreciated that although only one set of rollers 208 is shown in FIGS. 9 and 10, both sets of rollers can have an identical configuration and can be manipulated as in shown in the depicted example.

Specifically, in the example roller configuration shown in FIG. 9, roller configuration 248, rollers 208 are in an arrangement that bends and/or flexes ring-shaped blade 210 into a more acute angle e. In this example, an axis C-C between central rotational axes 250 of outer rollers 246 is farther from an apex 252 of flexed ring-shaped blade 210 than a central rotational axis 254 of central roller 244. In other words, outer rollers 246 are moved away from apex 252 so that ring-shaped blade 210 is flexed to a greater degree.

In another example roller configuration 256 shown in FIG. 10, rollers 208 are in an arrangement that bends and/or flexes ring-shaped blade 210 into a less acute angle f. In this example, the angle f is greater than the angle e. As depicted in FIG. 10, in roller configuration 256 axis C-C is closer to apex 252 than central rotational axis 254. In other words, outer rollers 246 are moved toward apex 252 so that ring-shaped blade 210 is flexed to a lesser degree.

Thus, by changing the distance of rollers rotational axes relative to each other and an apex of the flexed area of the ring-shaped blade, the cutting portion of the blade can be made to change its curvature. The rollers act in tandem and/or cooperatively to produce the desired curvature or ogee curve needed to make a cut. It will be appreciated that the position of the rollers can be adjusted into various configurations to produce a desired flex of the ring-shaped blade. Further, it will be appreciated that a computer numerically controlled (CNC) system could shift the rollers in a controlled and reproducible way for the purpose of manufacturing contours and curved parts with complex curved profiles that change over the length of the cut.

Similarly to handles 108, sets of rollers 208 can be manipulated and/or articulated to produce a desired width, curvature, shape, and/or direction of a cut. First set of rollers 212 (i.e., a set of rollers on a right side) and a second set of rollers 214 (i.e., a set of rollers on a left side) work cooperatively and/or in tandem to produce a desired curvature or ogee curve to make a cut during a cutting operations. Moreover, sets of rollers 212 and 214 can be manipulated to produce a cut that changes in width, curvature, shape, and/or direction over the course of the cut. In some examples, work piece 204 can be moved across the cutting portion of ring-shaped blade 210. In other examples, work piece 204 is a stationary work piece.

FIGS. 11-13 show example curvature configurations for saw 200. FIG. 11 depicts the cutting portion of the ring flexed into an obtuse curvature 258. In the example shown in FIG. 11, sets of rollers 212 and 214 are moved farther apart, having a distance g between the sets of rollers. FIG. 12 depicts the cutting portion of the ring flexed into an acute curvature 260. In the example shown in FIG. 12, sets of rollers 212 and 214 are moved closer together, having a distance h between the sets of rollers. In these examples, the distance g is greater than the distance h.

In an alternate example, FIG. 13 depicts the cutting portion of the ring flexed into a double curve or ogee shape 262. In this example, set of rollers 214 is manipulated and/or articulated differently or unequivalently with set of rollers 212. Set of rollers 214 is adjusted to be more parallel with a surface of work piece 204, while set of rollers 212 are more perpendicular to the surface of work piece 204. It will be appreciated that the sets of rollers can be manipulated and/or articulated in various desired positions of the rollers and/or various desired cooperative configurations to produce a desired cut. It will be further appreciated that although the present example includes two sets of rollers, more sets of rollers may be used to adjust the ring-shaped blade during a cutting operation.

Turning now to FIG. 14, a specific configuration for a saw blade, saw blade 310, is shown. Saw blade 310 is made of a flexible material, such as metal or plastic, embedded with a harder abrasive material 364, such as diamond, carbide, and/or ceramic pieces. Blade 310 can be used in either of saw 100 or saw 200, described above. The abrasive material-embedded teeth allow the saw to be used to cut more rigid materials, such as stone, earth, rigid foam, etc. It will be appreciated that although abrasive material 364 is shown only in lower cutting edge 322, in alternate examples, the abrasive material may be included in upper cutting edge 320.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A saw configured to allow change in a width, a direction, and a curvature of a cut during a cutting operation, the saw comprising:
a saw blade, the saw blade being more flexible along a longitudinal axis of the saw blade and more rigid along a vertical axis of the saw blade, the saw blade having
a blade body, and
a plurality of cutting teeth, the plurality of cutting teeth being disposed on a lower cutting edge of the blade body.

2. The saw of claim 1, wherein the plurality of cutting teeth are further disposed on an upper cutting edge of the blade body.

3. The saw of claim 1, wherein the vertical axis is a direction of cutting axis during the cutting operation.

4. The saw of claim 1, wherein the saw blade is configured to be flexed by manipulation of at least two articulating points on the saw blade during the cutting operation to change one or more of the width, the direction, and the curvature of the cut.

5. The saw of claim 4, wherein the blade body is an arched blade body, and the blade body further comprises a right-handed handle disposed on a first end of the blade body and a left-handed handle disposed on a second opposing end of the blade body, the right handed-handle and the left-handed handle being the at least two articulating points.

6. The saw of claim 5, wherein the right-handed handle is configured to be levered and sawed by a user to steer the saw in a leftward direction during the cutting operation, and the left-handed handle is configured to be levered and sawed by the user to steer the saw in a rightward direction during the cutting operation.

7. The saw of claim 5, wherein the right-handed handle and the left-handed handle are configured to be moved closer together to decrease the width and increase the curvature of the cut during the cutting operation, and the right-handed handle and the left-handed handle are configured to be moved farther apart to increase the width and decrease the curvature of the cut during the cutting operation.

8. The saw of claim 1, wherein the saw blade is comprised of a flexible material having embedded abrasive pieces.

9. The saw of claim 1, wherein the saw blade comprised of a flexible material with elastic memory, the saw blade being coilable into a coiled storage position for packing and storage of the saw.

10. The saw of claim 3, wherein the saw blade is configured to be a continuous ring-shaped blade.

11. The saw of claim 10, wherein the ring-shaped blade further comprises two sets of rollers configured to flex the blade, the two sets of rollers being the at least two articulating points.

12. The saw of claim 11, wherein the two sets of rollers are further configured to change the width and the curvature of a cut during the cutting operation via flex of the ring-shaped blade at the at least two articulating points.

13. The saw of claim 10, wherein the ring-shaped blade is driven by a motor.

14. A saw configured to allow a change in a width, a direction, and a curvature of a cut during a cutting operation, the saw comprising:
a saw blade, the saw blade having
a blade body, and
a plurality of cutting teeth, the plurality of cutting teeth being disposed on an upper cutting edge of the blade and a lower cutting edge of the blade body,
wherein the saw blade is configured to be flexed by manipulation of at least two articulating points on the saw blade during the cutting operation to change one or more of the width, the direction, and the curvature of the cut.

15. The saw of claim 14, wherein the blade body is an arched blade body, and the blade body further comprises a right-handed handle disposed on a first end of the blade body and a left-handed handle disposed on a second opposing end of the blade body, the right handed-handle and the left-handed handle being the at least two articulating points.

16. The saw of claim 15, wherein the right-handed handle is configured to be levered and sawed by a user to steer the saw in a leftward direction during the cutting operation, and the left-handed handle is configured to be levered and sawed by the user to steer the saw in a rightward direction during the cutting operation.

17. The saw of claim 15, wherein the right-handed handle and the left-handed handle are configured to be moved closer together to decrease the width and increase the curvature of the cut during the cutting operation, and the right-handed handle and the left-handed handle are configured to be moved farther apart to increase the width and decrease the curvature of the cut during the cutting operation.

18. The saw of claim 10, wherein the saw blade is configured to be a continuous ring-shaped blade driven by a motor.

19. The saw of claim 18, wherein the ring-shaped blade further comprises two sets of rollers configured to flex the blade to change the width and the curvature of the cut during the cutting operation, the two sets of rollers being the at least two articulating points.

20. A snow saw configured to allow a change in a width, a direction, and a curvature of a cut into a snow pack during a cutting operation to construct a snow shelter, the snow saw comprising:
a saw blade, the saw blade being more flexible along a longitudinal axis of the saw blade and more rigid along a vertical axis of the saw blade, the saw blade being comprised of a flexible material having elastic memory, the saw blade having
a blade body, and
a plurality of cutting teeth, the plurality of cutting teeth being disposed on an upper cutting edge of the blade body and a lower cutting edge of the blade body,
wherein the saw blade is configured to be flexed by manipulation of at least two articulating points on the saw blade during the cutting operation through the snow pack to change one or more of the width, the direction, and the curvature of the cut.
